(19) United States
(12) Patent Application Publication
(10) Pub. No.: US 2005/0166377 A1
(43) Pub. Date: Aug. 4, 2005

(54) Device for assemblig a vehicle seat

(76) Inventors: Pierre Orlewski, Keispelt (LU); Roland Lorig, Sinspelt (DE)

Correspondence Address: CANTOR COLBURN, LLP, 55 GRIFFIN ROAD SOUTH, BLOOMFIELD, CT, 06002, US

(21) Appl. No.: 10/512,805

(22) PCT Filed: Apr. 25, 2003
(86) PCT No.: PCT/EP03/50128

(30) Foreign Application Priority Data
May 2, 2002 (LU) 90 917

(51) Int. Cl. B68G 7/00; B23P 21/00

(52) U.S. Cl. 29/91.1; 29/91; 29/771; 29/784; 29/787

(57) ABSTRACT

“A device for assembling a vehicle seat having a seat upholstery and a sensing mat. The device includes a first supporting device having a receiving surface for receiving the sensing mat and a second supporting device for receiving the seat upholstery, the first and second supporting devices being movable with respect to each other so as to bring the seat upholstery and the sensing mat into contact with each other. The first supporting device includes at least one positioning means for positioning and maintaining the sensing mat in a predefined position with respect to the first supporting device and at least one actuatable embedding means for embedding a portion of the sensing mat into a recess of the seat upholstery, the actuatable embedding means being movable from an extended position, in which the embedding means extend above the receiving surface of the first supporting device and a retracted position, in which the embedding means are positioned below the receiving surface of the first supporting device.”

### INTRODUCTION

The present invention relates to a device for assembling a vehicle seat, and more specifically to a device for assembling a vehicle seat comprising at least one seat occupancy sensor.

In order to protect the life of passengers during a traffic accident, modern vehicles are generally equipped with a protection system comprising several airbags and seat belt pretensioners, which are used to absorb the energy of a passenger released during the collision due to the accident. In order to deploy the airbags of the passenger seat only in the case where this seat is actually occupied by a person, passenger detectors have been developed that indicate the presence of a passenger to the control unit of the protection system. Other detectors have been developed which are used to evaluate the weight or the position of the occupant of the seat, this information enabling the microprocessor to deploy the airbag in a mode, which is adapted to the actual occupancy status of the seat.

The detectors for detecting and evaluating occupancy often comprise a foil type pressure sensing mat, which is integrated in the vehicle seat, e.g. between the seat trim and the seat upholstery. The sensor mat comprises a plurality of active pressure sensing cells, which are distributed over the seating surface of the seat. Based on the force acting on the different pressure sensing cells, a microprocessor evaluates a pressure distribution profile acting on the seat and based on this pressure profile switches the airbag in a deployment modus, which is best adapted to the current occupancy status.

The pressure sensing mat is usually mounted between the seat upholstery and the seat trim. During the assembly of the vehicle seat, the pressure sensing mat is fixed to the upholstery, e.g. the seat foam, and subsequently the seat trim is placed over the pressure sensing mat and the foam. The pressure sensing mat may be fixed to the seat foam e.g. by means of double sided adhesive, or by means of hook and loop fasteners, etc. In some cases, an intermediate layer, e.g. a decoupling layer made of spacer fabric, a fleece layer or a seat heating, is mounted between the sensing mat and the seat upholstery. In this case the intermediate layer is fixed on the seat foam and the sensing mat is fixed to the intermediate layer.

It is clear that a correct positioning of the sensing mat with respect to the seat upholstery is a prerequisite for the correct operation of the airbag control module. The correct positioning of the sensing mat is especially critical in the case of a three dimensional sensing mat, i.e. a sensing mat having several regions which are bend transversely to the seating surface in order to extend e.g. into crimping channels of the seat foam. In fact, during the embedding of these bend regions of the sensor mat into the crimp channels, the dimension of the sensing mat in the transverse direction of the crimp channel decreases, resulting in a change of the position of the sensing mat with respect to the seat foam.

Hence there is a need for a device for assembling a vehicle seat, which reduces the risk of bad positioning of the sensing mat with respect to the seat upholstery.

### OBJECT OF THE INVENTION

The object of the present invention is to provide such a device for seat assembly and a method for assembling a vehicle seat.

### GENERAL DESCRIPTION OF THE INVENTION

In order to overcome the abovementioned problems, the present invention proposes a device for assembling a vehicle seat comprising a seat upholstery and a sensing mat. The device comprises a first supporting device having a receiving surface for receiving said sensing mat and a second supporting device for receiving said seat upholstery, said first and second supporting devices being movable with respect to each other so as to bring said seat upholstery and said sensing mat into contact with each other. The first supporting device comprises at least one positioning means for positioning and maintaining said sensing mat in a predefined position with respect to said first supporting device and at least one actuatable embedding means for embedding a portion of said sensing mat into a recess of said seat upholstery, said actuatable embedding means being movable from an extended position, in which said embedding means extend above said receiving surface of said first supporting device and a retracted position, in which said embedding means are positioned below said receiving surface of said first supporting device.

With the device of the present invention, the sensing mat can be positioned onto a substantially flat surface of the first supporting device. This deployment of the sensing mat on a flat surface is easily achieved and the correct positioning can easily be controlled. The mat can e.g. be correctly positioned using the positioning means, e.g. a plurality of tappets which extend above the receiving surface of said first supporting device, said tappets for co-operating with respective notches of said sensing mat, and/or a plurality of vacuum valves integrated into said receiving surface of said first supporting device, thereby ensuring a correct positioning with respect to the seat upholstery supported by the second supporting device. After the sensing mat is correctly positioned, the second supporting device is moved towards the first supporting device the seat upholstery is placed into contact with said sensing mat on said first supporting device.

It should be noted, that the assembling process could comprise the further step of positioning a one or more layers such as a decoupling layer or padding onto said sensing mat after said sensing mat is positioned onto said first supporting device and prior to placing said seat upholstery onto said sensing mat.

Only after the seat upholstery is placed onto the sensing mat and if applicable a decoupling layer or padding, the embedding means integrated into said first supporting device are actuated, whereby the portion of said sensing mat lying on said embedding means is embedded into a recess of said seat upholstery. The positioning means ensure that the sensing mat maintains its previously adjusted correct position with respect to the seat upholstery.

Finally the sensing mat can be fixed to said seat upholstery, e.g. by exerting a pressure onto a portion of said sensing mat having a double sided adhesive or a stripe of Velcro-like hooks affixed thereon.

In a preferred embodiment said embedding means comprises an actuatable cylinder which extends along the receiving surface of said first supporting device in a direction which corresponds to the direction of a recess of a seat upholstery mounted on said second supporting device. If the actuatable cylinder is actuated, the sensing mat is embedded into the recess, e.g. the crimp channel of the seat upholstery, over the entire length of the cylinder. The cylinder preferably has a length which equals the length of the crimp channel, so that the sensing mat is embedded over the entire crimp channel. In an alternative embodiment said embedding means comprises a plurality of vertically movable dies, said movable dies being integrated into said first supporting device at locations, which are opposite to a recess of a seat upholstery mounted on said second supporting device. With such a device, the sensing mat can be locally embedded into the respective recess at selected locations only. It should be noted that a device for assembling a vehicle seat may comprise a combination of the two described embodiments of the embedding means.

In order to compensate for the lateral retraction of a sensing mat when a portion of said sensing mat is bend transversely to the receiving surface, the positioning means are preferably coupled to said actuatable embedding. In other words, at least a part of the positioning means is preferably movable and coupled to the embedding means in such a way that said movable positioning means is displaced towards said embedding means when said embedding means is displaced from said retracted position to said extended position.

Depending on the embodiment of the positioning means this means that at least one of said tappets or at least one of said vacuum valves is laterally movable and coupled to said actuatable embedding means in such a way that said tappet or said vacuum valve is displaced in the direction of said embedding means when said embedding means is displaced from said retracted position to said extended position for compensating a lateral retraction of a sensing mat when a portion of said sensing mat is embedded into a recess of said seat upholstery.

In an advantageous embodiment of the invention, said second supporting means is mounted on a swivel arm, said swivel arm being pivotable between a first position wherein said second supporting device is positioned above said first supporting device and a second position wherein said second supporting device is positioned laterally of said first supporting device. This embodiment enables said second supporting device to be positioned into said second position prior to mounting said seat upholstery onto said second supporting device. Thus the correct positioning of the seat upholstery onto the second supporting device is made easier as the accessibility of the second supporting device is improved. If said second supporting device is rotatably mounted on said swivel arm, the second supporting device may further be rotated so that the seat upholstery may be simply be put on the supporting device.

It should be noted that this embodiment provides the further advantage that after said sensing mat is fixed to said seat upholstery, the second supporting device can be positioned together with said seat upholstery and said sensing mat into said second position and rotated so that said seat upholstery and said sensing mat are accessible from above. In this position a seat trim can easily be pulled over said assembles sensing mat and seat upholstery and if applicable post assembly tests can be performed.

In a preferred embodiment of the device, said first supporting device comprises a substantially horizontal central portion and at least one lateral portion, said lateral portion being pivotably mounted to said central portion so as to be movable between a horizontal position, in which an upper surface of said lateral portion is substantially aligned with an upper surface of said central portion, and an inclined position, in which said upper surface of said lateral portion is extends downwards from said upper surface of said central portion. In this embodiment, the central portion of the first supporting device supports the central part of the sensing mat while the lateral portion of the first supporting device is used to support the side part of the sensing mat which is mounted onto the side bolsters of the seat. The assembly process then advantageously comprises the further steps of:
moving said lateral portion into said horizontal position prior to positioning said sensing mat onto said first supporting device;
moving said lateral portion into said inclined position after said sensing mat is positioned onto said first supporting device and prior to placing said seat upholstery into contact with said sensing mat;
moving said lateral portion towards said horizontal position until a lateral portion of the sensing mat positioned on said lateral portion of said first supporting device comes into contact with a lateral portion of said seat upholstery.

Here again, the sensing mat is deployed onto an entirely flat surface after which the side portions of the sensing mat are transversely bend with respect to this flat surface.

It should be noted that the side portions of the sensing mat are preferably maintained onto the lateral portion of the first supporting device by means of at least one positioning means which is movably mounted on said at least one lateral portion, said positioning means being displaced in the direction of said central portion when said lateral portion is displaced from said horizontal position into said inclined position.

As already stated, the sensing mat may be fixed to the seat upholstery by means of several stripes of double sided adhesive of several stripes of Velcro-like hooks (microplast). In order to ensure a good adhesion between the two elements, the first and second supporting device are preferably pressed together with a specific force. In order to increase the pressure in the adhering regions, the device may further comprise a plurality of pressing means integrated into said first supporting device, said pressing means for locally exerting a pressure on said sensing mat for pressing said sensing mat onto said seat upholstery after said seat upholstery has been brought into contact with said sensing mat.

### DETAILED DESCRIPTION WITH RESPECT TO THE FIGURES

The present invention will be more apparent from the following description of a not limiting embodiment with reference to the attached drawings, wherein

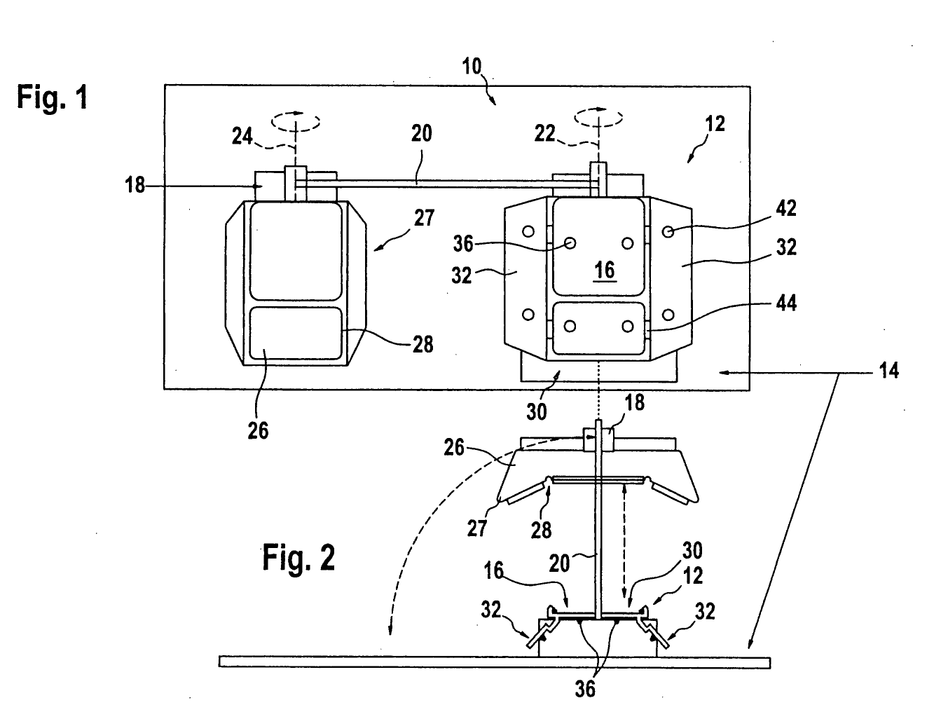

FIG. 1: shows a top view of a device for assembling a vehicle seat prior to the sensor assembly;

FIG. 2: shows a front view of a device for assembling a vehicle seat after the sensor assembly;

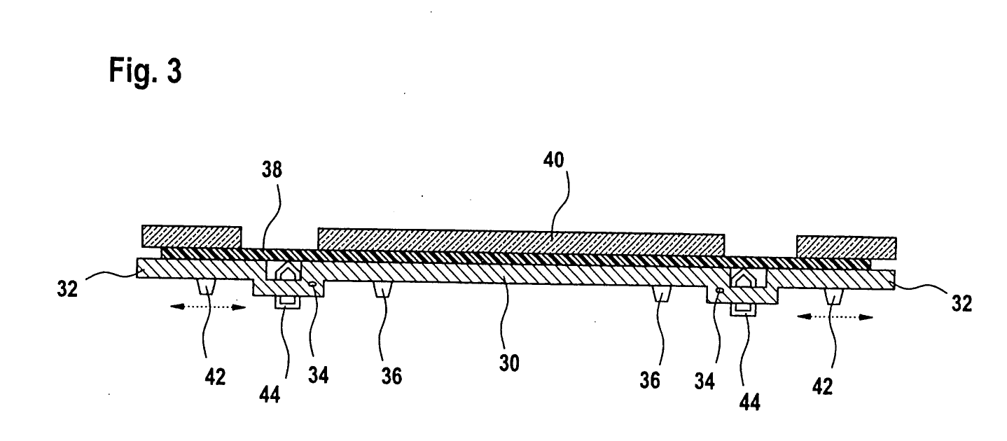

FIG. 3: shows an enlarged view of a section of a first supporting device;

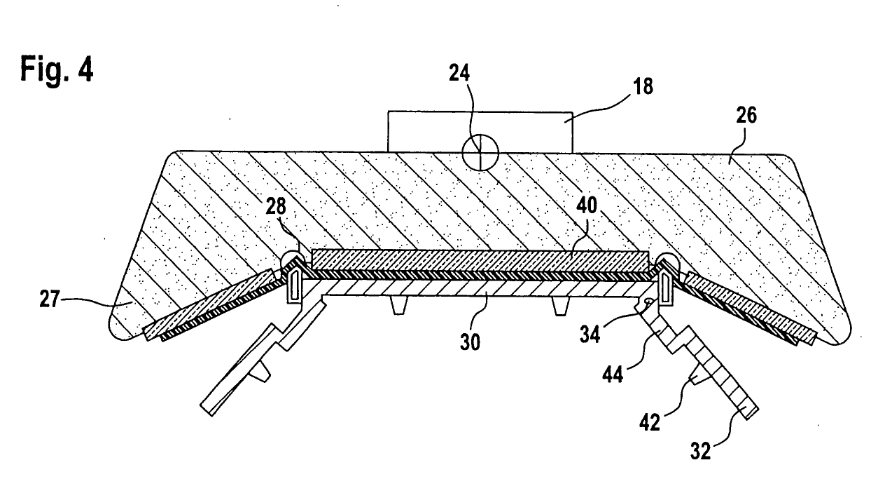

FIG. 4: shows a section of the first supporting device after the sensing mat is attached to the seat upholstery;

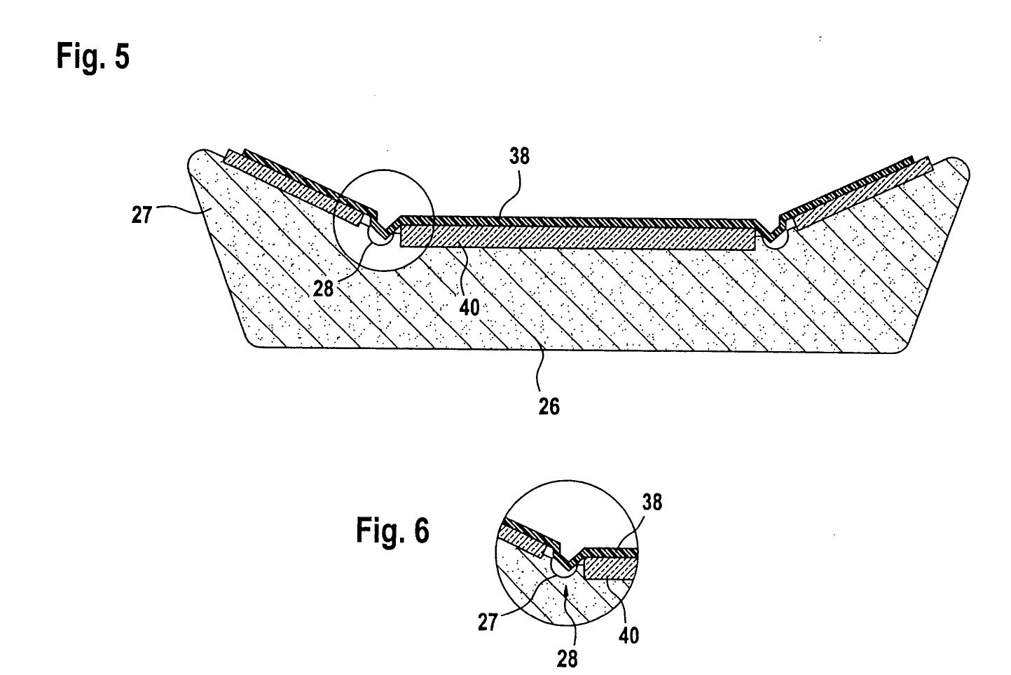

FIG. 5: shows a seat upholstery with assembled sensor;

FIG. 6: shows a detailed view of the sensor bend and embedded into the foam's crimp channel.

A top view of a device 10 for assembling a vehicle seat is shown in FIG. 1 prior to the sensor assembly. A front view of the device 10 after sensor assembly is shown in FIG. 2.

The device 10 comprises a supporting plate 12 mounted on an assembly table 14. The supporting plate 12 has an upper surfaces which forms a receiving surface 16 for receiving a sensing mat to be assembled to a seat foam. A second supporting device 18 is mounted to the first supporting plate 12 by means of a swivel arm 20, which is pivotable about an axis 22 between a first position wherein the second supporting device 18 is positioned above said first supporting device (shown in FIG. 2) and a second position wherein said second supporting device 18 is positioned laterally of said supporting plate 12.

The second supporting device 18 is preferably rotatably mounted about an axis 24 on said swivel arm 20, so that the second supporting device 18 may be positioned with its receiving surface up.

In its second position (as shown in FIG. 1), the second supporting device 18 is easily accessible for placing and securing a seat upholstery or seat foam 26 onto the second supporting device 18. The seat foam comprises a central part forming the seating surface (A-surface) and side bolsters 27. The A-surface and the side bolsters are separated by crimp channels 28, which are used to crimp a seat trim onto the seat foam. The seat foam may be placed with its seating surface facing upwardly, thus enabling a visual control of the seating surface and the crimp channels 28 provided into the foam.

The supporting plate comprises a substantially horizontal central portion 30 and two lateral portions 32. The lateral portions 32 are pivotably mounted to said central portion 30 so as to be pivotable about an axis 34 between a horizontal position (shown in FIG. 3), in which an upper surface of said lateral portion 32 is substantially aligned with the upper surface of said central portion 30, and an inclined position (shown in FIG. 4), in which said upper surface of said lateral portion extends downwards from said upper surface of said central portion.

Positioning means 36 such as tappets, which extend above the receiving surface of said first supporting device, or vacuum valves are integrated into said supporting plate 12. Preferably positioning means 36 are integrated as well in the central portion 30 as in the lateral portions 32.

Prior to the deployment of the sensing mat, the lateral portions 32 of the supporting plate 12 are moved into their respective horizontal position. This position is e.g. shown in FIG. 3. The lateral portions thus form together with the central position 30 a substantially flat receiving surface 16 for the sensing mat. The sensing mat 38 is then positioned onto the receiving surface, whereby the correct position is ensured by the positioning means 36. The positioning means may e.g. comprise vacuum valves which are integrated into the receiving surface. A vacuum applied to these vacuum valves maintains the sensing mat safely in its correct position with respect to the supporting plate 12.

After the sensor 38 is deployed, a further optional layer 40 such as e.g. a decoupling layer, a foam padding or a heating mat may be positioned on the sensing mat.

It should be noted that the sensor and all the optional layers are preferably positioned with the second supporting device 18 being in its second position laterally from the supporting plate. In this position, the access to the supporting plate 12 is not restricted by the second supporting device 18.

After the sensor is positioned, the swivel arm 20 of the second supporting device 18 is rotated about axis 22 into its first position above the supporting plate 18. At the same time supporting device 18 is rotated about axis 24 in order to orient the seating surface so as to face the sensing mat on the supporting plate. The lateral portions 32 of the supporting plate are then preferably displaced into their respective inclined portions, while the sensors wings supported by the lateral portions are hold by positioning means 42, e.g. vacuum valves. In order to compensate for the movement of the sensor's side wings with respect to the lateral portions during this movement, the positioning means 42 on the lateral portions are preferably movably mounted on said lateral portion. The positioning means 42 may then be displaced towards said central portion 30 when said lateral portion 32 is displaced from said horizontal position into said inclined position.

After this step, the second supporting device 18 is moved towards the supporting plate 12, whereby the seat foam is pressed onto the sensing mat 38 and the decoupling layer 40.

In order to embed different portions of the sensor into the crimp channels 28 of the foam, embedding means 44 are provided in the supporting plate 12. In the shown embodiment, the embedding means comprise a plurality of vertically movable dies, which are integrated into the supporting plate 12 at locations, which are opposite to a recess of foam. The embedding means 44 are moved from their retracted position (FIG. 3), in which said embedding means are positioned below said receiving surface 16 of said supporting plate, to their extended position (FIG. 4), in which said embedding means 44 extend above said receiving surface 16. The sensing mat is thereby bend transversely to the receiving surface and inserted into the respective crimp channel (see also FIG. 6).

In order to compensate for the lateral retraction of a sensing mat 38 when a portion of said sensing mat is bend transversely to the receiving surface, at least a part of the positioning means are preferably coupled to said actuatable embedding means. In other words, at least a part of the positioning means is preferably movable and coupled to the embedding means in such a way that said movable positioning means is displaced towards said embedding means when said embedding means is displaced from said retracted position to said extended position.

After this step, the lateral portions 32 of the supporting plate are moved up, thereby bringing the sensor's side wings into contact with the foams side bolsters 27. Consequently the lateral portions may pivot again into their inclined portion, thereby releasing the sensor's side portions.

The assembly of the sensing mat to the foam is now achieved. The second supporting device together with the foam and the affixed sensor can then be rotated into the second position of the second supporting device, where a seat trim may be placed on the seat and after assembly tests performed.

1. A device for assembling a vehicle seat, said vehicle seat comprising a seat upholstery and a sensing mat, the device comprising: a first supporting device having a receiving surface for receiving said sensing mat and a second supporting device for receiving said seat upholstery, said first and second supporting devices being movable with respect to each other so as to bring said seat upholstery and said sensing mat into contact with each other, wherein said first supporting device comprises at least one positioning means for positioning and maintaining said sensing mat in a predefined position with respect to said first supporting device and at least one actuatable embedding means for embedding a portion of said sensing mat into a recess of said seat upholstery, said actuatable embedding means being movable from an extended position, in which said embedding means extend above said receiving surface of said first supporting device and a retracted position, in which said embedding means are positioned below said receiving surface of said first supporting device.

2. The device according to claim 1, wherein said embedding means comprises an actuatable cylinder which extends along the receiving surface of said first supporting device in a direction which corresponds to the direction of a recess of a seat upholstery mounted on said second supporting device.

3. The device according to claim 1, wherein said embedding means comprises a plurality of vertically movable dies, said movable dies being integrated into said first supporting device at locations, which are opposite to a recess of a seat upholstery mounted on said second supporting device.

4. The device according to claim 1, wherein said positioning means are coupled to said actuatable embedding means for compensating a lateral retraction of a sensing mat when a portion of said sensing mat is embedded into a recess of said seat upholstery.

5. The device according to claim 1, wherein said positioning means comprises a plurality of tappets which extend above the receiving surface of said first supporting device, said tappets for cooperating with respective notches of said sensing mat.

6. The device according to claim 5, wherein at least one of said tappets is laterally movable and coupled to said actuatable embedding means in such a way that said tappet is displaced towards said embedding means when said embedding means is displaced from said retracted position to said extended position for compensating a lateral retraction of a sensing mat when said portion of said sensing mat is embedded into a recess of said seat upholstery.

7. The device according to claim 1, wherein said positioning means comprises a plurality of vacuum valves integrated into said receiving surface of said first supporting device.

8. The device according to claim 7, wherein at least one of said vacuum valves is laterally movable and coupled to said actuatable embedding means in such a way that said vacuum valve is displaced towards said embedding means when said embedding means is displaced from said retracted position to said extended position for compensating a lateral retraction of a sensing mat when a portion of said sensing mat is embedded into a recess of said seat upholstery.

9. The device according to claim 1, wherein said second supporting means is mounted on a swivel arm, said swivel arm being pivotable between a first position wherein said second supporting device is positioned above said first supporting device and a second position wherein said second supporting device is positioned laterally of said first supporting device.

10. The device according to claim 9, wherein said second supporting device is rotatably mounted on said swivel arm.

11. The device according to claim 1, wherein said first supporting device comprises a substantially horizontal central portion and at least one lateral portion, said lateral portion being pivotably mounted to said central portion so as to be movable between a horizontal position, in which an upper surface of said lateral portion is substantially aligned with an upper surface of said central portion, and an inclined position, in which said upper surface of said lateral portion is extends downwards from said upper surface of said central portion.

12. The device according to claim 11, wherein at least one positioning means is movably mounted on said at least one lateral portion, said positioning means being displaced in the direction of said central portion when said lateral portion is displaced from said horizontal position into said inclined position.

13. The device according to claim 1, further comprising a plurality of pressing means integrated into said first supporting device, said pressing means for locally exerting a pressure on said sensing mat for pressing said sensing mat onto said seat upholstery after said seat upholstery has been brought into contact with said sensing mat.

14. A process for assembling a vehicle seat, said vehicle seat comprising a seat upholstery and a sensing mat, said method comprising the steps of:
a) positioning said sensing mat on a substantially flat receiving surface of a first supporting device, said sensing mat being positioned and maintained by means of positioning means;
b) placing said seat upholstery into contact with said sensing mat on said first supporting device;
c) embedding a portion of said sensing mat into a recess of said seat upholstery by actuating embedding means integrated into said first supporting device, said embedding means bending said portion of said sensing mat and inserting said portion into said recess;
d) fixing said sensing mat to said seat upholstery.

15. The process according to claim 14, further comprising the step of positioning a decoupling layer onto said sensing mat after said sensing mat is positioned onto said first supporting device and prior to placing said seat upholstery onto said sensing mat.

16. The process according to claim 14, wherein said seat upholstery is positioned onto a second supporting device prior to placing said seat upholstery onto said sensing mat, wherein said second supporting device is movable with respect to said first supporting device so as to bring said seat upholstery and said sensing mat into contact with each other.

17. The process according to claim 16, wherein said second supporting means is rotatably mounted on a swivel arm, said swivel arm being pivotable between a first position wherein said second supporting device is positioned above said first supporting device and a second position wherein said second supporting device is positioned laterally of said first supporting device, said process further comprising the step of positioning said second supporting device into said second position prior to mounting said seat upholstery onto said second supporting device.

18. The process according to claim 14, wherein said first supporting device comprises a substantially horizontal central portion and at least one lateral portion, said lateral portion being pivotably mounted to said central portion so as to be movable between a horizontal position, in which an upper surface of said lateral portion is substantially aligned with an upper surface of said central portion, and an inclined position, in which said upper surface of said lateral portion is extends downwards from said upper surface of said central portion, said process further comprising the steps of:
a) moving said lateral portion into said horizontal position prior to positioning said sensing mat onto said first supporting device;
b) moving said lateral portion into said inclined position after said sensing mat is positioned onto said first supporting device and prior to placing said seat upholstery into contact with said sensing mat;
c) moving said lateral portion towards said horizontal position until a lateral portion of the sensing mat positioned on said lateral portion of said first supporting device comes into contact with a lateral portion of said seat upholstery.

19. The process according to claim 17, comprising the further steps of
a) after said sensing mat is fixed to said seat upholstery, positioning said second supporting device together with said seat upholstery and said sensing mat into said second position;
b) rotating said second supporting device so that said seat upholstery and said sensing mat are accessible from above; and
c) pulling a seat trim over said assembles sensing mat and seat upholstery.

20. The process according to claim 18, comprising the further steps of
a) after said sensing mat is fixed to said seat upholstery, positioning said second supporting device together with said seat upholstery and said sensing mat into said second position;
b) rotating said second supporting device so that said seat upholstery and said sensing mat are accessible from above; and
c) pulling a seat trim over said assembles sensing mat and seat upholstery.
